(19) United States
(12) Patent Application Publication
(10) Pub. No.: US 2012/0059132 A1
(43) Pub. Date: Mar. 8, 2012

(54) POLYLACTIC ACID-BASED RESIN COMPOSITION AND METHOD FOR MANUFACTURING THE SAME

(75) Inventors: Yasuo Kawashima, Aichi (JP); Yasuhiro Fujii, Aichi (JP); Takeshi Kanamori, Aichi (JP)

(73) Assignee: TOYOTA JIDOSHA KABUSHIKI KAISHA, Toyota-shi, Aichi (JP)

(21) Appl. No.: 13/321,137

(22) PCT Filed: May 19, 2009
(86) PCT No.: PCT/JP2009/059486

§ 371 Date: Nov. 17, 2011

(51) Int. Cl. C08L 67/04; C08G 63/88; C08G 63/08

(52) U.S. Cl. 525/450; 528/354

(57) ABSTRACT

As pellets suddenly soften by crystallization heat at a temperature equal to or higher than the glass transition temperature due to the characteristics of polylactic acid and a blocking phenomenon occurs, there is a need for inhibiting the blocking phenomenon. It is thus an object of the present invention to improve productivity of a polylactic acid resin and a polylactic acid-based resin composition comprising polylactic acid as a main component by inhibiting the blocking phenomenon. Aiming at solving above problems, in the present invention, a resin composition comprising polylactic acid or a blend of polylactic acid and another resin obtained by manufacturing the polylactic acid by polymerization or blending the polylactic acid and the another resin after manufacturing the polylactic acid is subjected to a heat treatment at a temperature of the glass transition temperature of polylactic acid ±10° C. for 15 minutes or more before a drying and crystallization treatment.

### TECHNICAL FIELD

The present invention relates to a polylactic acid-based resin composition and a method for manufacturing the same.

### BACKGROUND ART

Since polylactic acid is a high molecular weight compound having high safety in a living body, polylactic acid is used for medical purposes such as surgical suture threads, drug deliveries (sustained-release capsules), and reinforcement materials for broken bones, and has been attracting attention as a degradable plastic because polylactic acid degrades in the natural environment and produces lactic acid which is to be absorbed in a living body. In addition, polylactic acid is used in various applications such as uniaxially-stretched films, biaxially-stretched films, textiles, and injection molded products.

There are known methods for manufacturing such polylactic acid; a direct method in which lactic acid is directly dehydrated and condensed to produce a target polylactic acid and a method in which cyclic lactide (dimer) is first synthesized from lactic acid, and purified using a crystallization method or the like, and then, ring-opening polymerized. The operations for synthesis, purification, and polymerization of lactide are disclosed in, for example, U.S. Pat. No. 4,057,537, European Patent Publication No. 261,572, Polymer Bulletin, 14, 491-495 (1985), and Makromol. Chem., 187, 1611-1628 (1986). Furthermore, JP Patent Publication (Kokoku) No. 56-14688 B (1981) discloses that polylactic acid is manufactured by using two cyclic diester molecules as intermediates and polymerizing the diester molecules in the presence of tin octylate and lauryl alcohol as catalysts. In order to improve handling properties in a forming and processing process, polylactic acid thus obtained is beforehand formed into pellets having such a shape as a spherical shape, a cubic shape, a cylindrical shape, and a crushed shape with a size of about from a rice grain to a pea.

After polylactic acid is pelletized, a drying and crystallizing treatment is usually performed in order to remove moisture in the pellets. In the treatment, the pellets suddenly soften at a temperature equal to or higher than the glass transition temperature due to the characteristics of polylactic acid. As a result, in a manufacturing process, the adjacent pellets deform and contact to each other due to their own weights, and further, agglomerate, to cause the so-called blocking phenomenon. This remarkably reduces productivity and imposes a major problem in the manufacturing process. In addition, polylactic acid releases heat when crystallized at a temperature equal to or higher than its glass transition temperature. The temperature of the resin rapidly increases due to the crystallization heat. The elevated temperature leads to further softening of the pellets, which becomes a factor facilitating the occurrence of the blocking phenomenon. Furthermore, the same phenomenon as that described above may occur when a masterbatch comprising polylactic acid or a blend comprising polylactic acid is manufactured.

As measures against the blocking phenomenon, a device is required to be modified extensively, for example, the pellets in the drying treatment need to be stirred or caused to flow with setting the crystallization temperature lower and the heat treatment time longer. Alternatively, as other measures against the blocking phenomenon, JP Patent Publication (Kokai) No. 2005-105081 A and JP Patent Publication (Kohyo) No. 2002-542313 A disclose methods in which a blocking inhibitor is added in a small amount; however, the methods offer a higher cost and leave room for improvement.

### DISCLOSURE OF THE INVENTION

As the pellets suddenly soften by the crystallization heat at a temperature equal to or higher than its glass transition temperature due to the characteristics of polylactic acid and the blocking phenomenon occurs as mentioned above, there is a need for inhibiting the blocking phenomenon. It is thus an object of the present invention to improve productivity of a polylactic acid resin and a polylactic acid-based resin composition comprising polylactic acid as a main component by inhibiting the blocking phenomenon.

As a result of diligent study aimed at solving the above problems, the present inventors have found that it is possible to obtain a polylactic acid-based resin composition which can resist the blocking phenomenon in the drying and crystallizing treatment at a temperature ranging from the glass transition temperature +10° C. to the melting temperature by performing a heat treatment preliminarily on a polylactic acid resin or a resin composition obtained by blending polylactic acid and another resin at a temperature around the glass transition temperature which is determined by the DSC measurement in accordance with JIS K7121 and K7122 and completed the present invention. That is, the present invention provides the following aspects.

(1) A polylactic acid-based resin composition having a degree of crystallinity of 30% or less, comprising polylactic acid and having a specific heat capacity variation of 0.4 J/(g·° C.) or less in a temperature range of from 50° C. to 80° C., the specific heat capacity variation being measured by temperature-modulated differential scanning calorimetry in which a temperature is raised from 50° C. to 80° C. by multi-stages with temperature modulation for 10 minutes at each temperature under the conditions of a temperature modulation amplitude of ±0.5° C. and a temperature modulation period of 60 seconds.
(2) A method for manufacturing a polylactic acid-based resin composition having a degree of crystallinity of 30% or less according to (1), in which a resin composition comprising polylactic acid or a blend of polylactic acid and another resin obtained by manufacturing the polylactic acid by polymerization or blending the polylactic acid and the another resin after manufacturing the polylactic acid is subjected to a heat treatment at a temperature of the glass transition temperature of the polylactic acid ±10° C.
(3) The method for manufacturing a polylactic acid-based resin composition having a degree of crystallinity of 30% or less according to (2), in which the heat treatment is performed for 15 minutes or more.
(4) A method for manufacturing a polylactic acid-based resin composition having a degree of crystallinity of 30% or more, in which a drying and crystallizing treatment is further performed at a temperature ranging from the glass transition temperature of polylactic acid +10° C. to the melting temperature of the polylactic acid after the heat treatment according to (2).

By using the amorphous polylactic acid-based resin composition of the present invention, it is possible to inhibit the blocking phenomenon when the drying and crystallizing treatment is performed on the pellets at a temperature ranging from its glass transition temperature +10° C. to its melting temperature without using additives such as a blocking inhibitor, the blocking phenomenon being the characteristics of the conventional polylactic acid-based resin composition.

### BRIEF DESCRIPTION OF THE DRAWINGS

FIG. 1 is a view for explaining changes in reversing Cp obtained by temperature-modulated differential scanning calorimetry.

FIG. 2 is a view representing states of test samples before and after a heat treatment.

FIG. 3 is a view representing a state of a blocking phenomenon after a drying and crystallizing treatment.

### BEST MODE FOR CARRYING OUT THE INVENTION

Hereinafter, the present invention will be described in detail.

A polylactic acid-based resin composition of the present invention is a resin composition which comprises amorphous polylactic acid and can resist a blocking phenomenon in a drying and crystallizing treatment at a temperature ranging from the glass transition temperature of polylactic acid +10° C. to the melting temperature of the polylactic acid. Here, the glass transition temperature means a midpoint glass transition temperature which is an intersection point between a line which is at the same distance in vertical direction from extended lines of base lines and a curved line which is a stepwise changing portion of a heat flow indicating glass transition in the differential scanning calorimetry (DSC) as is defined in JIS K7121 “Testing Methods for Transition Temperatures of Plastics”. In addition, the melting temperature means a temperature at the top of a melting peak and a melting heat quantity means a heat quantity of melting transition as is defined in JIS K7122 “Testing Methods for Heat of Transitions of Plastics”. These values are obtained by the input compensation type differential scanning calorimetry or the heat flux differential scanning calorimetry.

Furthermore, an amorphous condition is defined as a condition having a degree of crystallinity of 30% or less, the degree of crystallinity being calculated by the following formula based on heat quantity data obtained by the differential scanning calorimetry (DSC measurement) (in accordance with JIS K7121 and K7122).

Degree of crystallinity (%)={(ΔHm−ΔHc)/ΔHf}×100 (Formula 1)

In the formula 1, ΔHm and ΔHc represent an endothermic enthalpy and an exothermic enthalpy of crystallization in the DSC measurement, respectively. ΔHf is 93 J/g which is a value described in a literature.

The polylactic acid-based resin composition of the present invention is intended to be a resin composition comprising polylactic acid having a melting temperature of 150° C. or more and a melting heat quantity of 20 J/g or more in the DSC measurement in accordance with JIS K7121 and K7122. The present invention may be applied to polylactic acid outside the above scope; in the case, however, the blocking phenomenon is originally hard to occur because such polylactic acid is amorphous.

The polylactic acid-based resin composition of the present invention has a specific heat capacity (reversing Cp) variation of 0.4 J/(g·° C.) or less in a temperature range of from 50° C. to 80° C., the specific heat capacity variation being measured by temperature-modulated differential scanning calorimetry in which a temperature is raised from 50° C. to 80° C. by multi-stages with temperature modulation for 10 minutes at each temperature under the conditions of a temperature modulation amplitude of ±0.5° C. and a temperature modulation period of 60 seconds. Raising a temperature by multi-stages means raising a temperature at least by two stages, and the measurement is performed with raising a temperature preferably by ten stages and more preferably by twenty stages. In the measurement, it is preferable to provide an inert gas such as nitrogen.

The temperature-modulated differential scanning calorimetry (modulated DSC) is a method in which a temperature is raised (lowered) at a constant speed as in the ordinal DSC method and, in addition, is periodically modulated to obtain beneficial information such as a specific heat capacity by corresponding changes in a heat flow. In the temperature-modulated differential scanning calorimetry, a total heat flow signal can be divided into a mechanical element (reversing heat flow) corresponding to specific heat changes and a dynamic element (non-reversing heat flow) by using the Fourier transformation, and it is possible to obtain a specific heat capacity (reversing Cp) by the reversing heat flow. When the amplitude of the temperature modulation is small enough, the measured signal is a sum of an element resulting from the temperature modulation (modulation element) and an element resulting from the temperature rise at a constant speed (constant speed element). Moreover, the reversing heat flow is equal to the total heat flow when there is no heat generation or absorption due to phase transition, a chemical reaction or the like.

Under a quasi-isothermal condition, the reversing Cp is equal to the specific heat capacity. A smaller specific heat capacity indicates that molecules are restrained and molecular motion is suppressed. On the contrary, a larger specific heat capacity indicates loose packing in molecules and that molecular motion becomes intense.

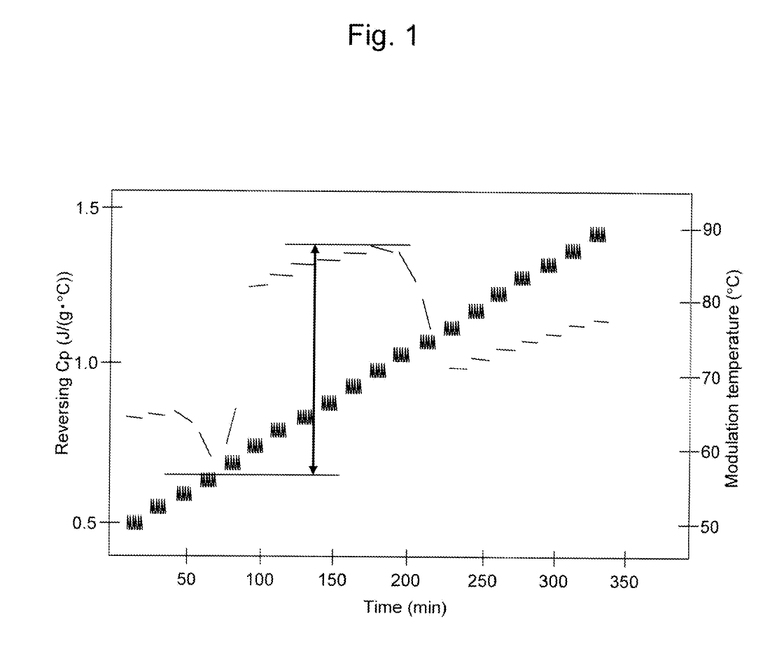

In the present invention, the specific heat capacity (reversing Cp) variation means a difference between the maximum value and the minimum value of the reversing Cp (the range indicated by the arrow) in a temperature range of from 50° C. to 80° C. as is illustrated in FIG. 1. Examples of a measurement device used for the temperature-modulated differential scanning calorimetry include, but are not limited to, DSC Q200 and Q2000 (name of product) manufactured by TA instruments.

As the polylactic acid-based resin composition of the present invention, polylactic acid alone or a blend comprising polylactic acid can be used. Specifically, a polylactic acid-based resin composition having a polylactic acid content of 50% by weight or more, preferably of 60% by weight or more, especially preferably of 80% by weight or more based on the total amount of the composition can be used.

The blend comprising polylactic acid may contain an additive or another resin. Examples of the additive include, but are not limited to, heretofore known plasticizers, hydrolysis inhibitors, crystal nucleus agents, lubricating agents, stabilizers, antistatic agents, antifog agents, ultraviolet absorbing agents, pigments, fungicides, antibacterial agents, and foaming agents. The additive may be added in any amount within the scope where the object of the present invention is not impaired. Specifically, the additive is added in an amount preferably of from 0.1% to 30% by weight based on the total amount of the composition. When the amount is less than 0.1% by weight, the additive generally does not exert its effect. Furthermore, as the polylactic acid-based resin composition of the present invention, for example, a masterbatch comprising 10% by weight of a hydrolysis inhibitor, a lubricating agent, or the like based on the total amount of the composition can be used.

Preferable examples of the hydrolysis inhibitor include, but are not limited to, heretofore known epoxy compounds and carbodiimide compounds. Examples of the carbodiimide compound include poly(4,4′-diphenylmethanecarbodiimide), poly(4,4′-dicyclohexylmethanecarbodiimide), poly(1,3,5-triisopropylbenzene)polycarbodiimide, poly(1,3,5-triisopropylbenzene)polycarbodiimide, and poly(1,5-diisopropylbenzene)polycarbodiimide. These compounds can be used alone or in combination of two or more.

Poly(4,4′-dicyclohexylmethanecarbodiimide) is available as a commercial product named CARBODILITE LA-1 (name of product; manufactured by Nisshin Spinning Co., Ltd.), poly(1,3,5-triisopropylbenzene)polycarbodiimide as Stabaxol P (name of product; manufactured by Rhein Chemie Rheinau GmbH), poly(1,3,5-triisopropylbenzene)polycarbodiimide and poly(1,5-diisopropylbenzene)polycarbodiimide as Stabaxol P-100 (name of product; manufactured by Rhein Chemie Rheinau GmbH), and N,N′-di-2,6-diisopropylphenylcarbodiimide as Stabaxol 1 (name of product; manufactured by Rhein Chemie Rheinau GmbH).

Examples of the lubricating agent include, but are not limited to, organic lubricating agents such as amide-based organic lubricating agents such as ethylene bis stearic acid amide, monoester-based organic lubricating agents, fatty acid salts, silicone-based compounds, carnauba waxes, and candelilla waxes. When an organic lubricating agent having an excellent dispersibility in the polylactic acid-based resin which is a base polymer and having a refractive index closer to that of the polylactic acid-based resin is selected, higher lubricating properties can be provided with relatively small decrease in transparency. Among the compounds mentioned above, the amide-based organic lubricating agent is especially preferably used regarding the dispersibility.

Furthermore, examples of the another resin which is to be blended with polylactic acid include, but are not limited to, thermoplastic resins such as polyethylene, polypropylene and acryl resins and thermosetting resins such as phenol resins, unsaturated polyester resins, and silicone resins. Especially, in view of compatibility with the polylactic acid resin, a resin containing a carbonyl group-containing bond such as an amide bond, an ester bond, and a carbonate bond is preferably used because such a resin tends to exhibit a higher affinity for the polylactic acid resin owing to its structure.

Hereinafter, a method for manufacturing the polylactic acid-based resin composition of the present invention will be described.

As a method for manufacturing polylactic acid, both a method of direct polymerization of lactic acid and a method of ring-opening polymerization of lactide can be employed. However, it is preferable to employ the latter method in order to manufacture polylactic acid having a higher molecular weight.

As lactic acid which is a raw material, L-lactic acid, D-lactic acid, DL-lactic acid, or a mixed material thereof can be used. When lactide which is a cyclic dimer of lactic acid is used as a raw material of lactic acid polymer, L-lactide, D-lactide, meso-lactide, or a mixed material thereof can be used.

By means of the direct polymerization or the ring-opening polymerization of lactide, polylactic acid having a weight-average molecular weight of 50,000 to 400,000 can be obtained. Here, the weight-average molecular weight of polylactic acid means a weight-average molecular weight only of a polymer portion obtained by the GPC measurement (in terms of polystyrene).

Polylactic acid may have a weight-average molecular weight at any value. However, when the molecular weight is smaller, pellets soften more drastically and the blocking phenomenon occurs more frequently in the drying and crystallizing treatment, and therefore, the present invention makes a larger contribution to the inhibition of the blocking phenomenon.

The obtained polylactic acid is then mixed with various additives and is blended with another resin as needed, and thus, the polylactic acid-based resin composition is manufactured. The resin composition is pelletized.

Examples of the shape of the pellets include a crushed shape, a square tip shape, a cylindrical shape, and a marble shape. Though the pellets do not need to have a specific shape, a cylindrical shape or a marble shape is preferred.

The size of the pellet is, but is not limited to, preferably 5 to 30 mg per pellet, and especially preferably 10 to 20 mg per pellet regardless of the shape of the pellets in view of heat-transfer effect on the pellets in the drying process, handling properties in the manufacturing process such as packing of the pellets, or handling properties in a secondary forming process.

Next, a drying and crystallizing treatment is performed on the pellets composed of the obtained polylactic acid-based resin composition.

In general, it is preferable to perform the drying and crystallizing treatment in a highly flowing condition in order to prevent the pellets from melting and adhering to each other because of the temperature exceeding a prescribed value due to the crystallization heat.

In the conventional methods, however, it is impossible to sufficiently inhibit the blocking phenomenon of the pellets resulting from the softening of polylactic acid and acceleration of the blocking phenomenon resulting from the crystallization heat even in the higher flowing condition.

Therefore, in the present invention, the resin composition is subjected to a heat treatment at a temperature of the glass transition temperature of polylactic acid ±10° C. before the drying and crystallizing treatment, which provides a reversing Cp variation of 0.4 J/(g·° C.) or less measured by temperature-modulated differential scanning calorimetry (modulated DSC) in which a temperature is raised from 50° C. to 80° C. by multi-stages with temperature modulation for 10 minutes at each temperature under the conditions of a temperature modulation amplitude of ±0.5° C. and a temperature modulation period of 60 seconds. By this, the blocking phenomenon can be inhibited drastically in the drying and crystallizing treatment at a temperature equal to or higher than the glass transition temperature +10° C.

In the present invention, the heat treatment is performed at a temperature of the glass transition temperature ±10° C., preferably of the glass transition temperature ±5° C., more preferably of from the glass transition temperature −5° C. to the glass transition temperature after the pellets are manufactured. When the temperature of the heat treatment is lower than the glass transition temperature −10° C., the reversing Cp variation cannot be within 0.4 J/(g·° C.), which causes the blocking phenomenon in the drying and crystallizing treatment at a temperature ranging from the glass transition temperature +10° C. to the melting temperature. This may be because bonds between molecules are strong at a temperature lower than the glass transition temperature −10° C. and the expected effect cannot be obtained with heat energy in this temperature range. On the contrary, when the temperature of the heat treatment is above the glass transition temperature +10° C., the blocking phenomenon resulting from sudden softening of a polylactic acid portion occurs. This may be because the pellets soften at a more rapid pace due to the crystallization heat of polylactic acid.

The major difference between amorphous pellets obtained by producing polylactic acid by polymerization, applying a strand cut method, and cooling (hereinafter, referred to as raw pellet) and pellets obtained by drying preliminarily at a temperature of the glass transition temperature ±10° C. in the preset invention is the reversing Cp variation. The reversing Cp of the raw pellets exceeds 0.4 J/(g·° C.) because the reversing Cp diminishes drastically when the temperature becomes closer to the glass transition temperature, and after that, rises drastically. On the contrary, in the case of the pellets composed of the amorphous polylactic acid-based resin composition obtained by the heat treatment at a temperature of the glass transition temperature ±10° C. in the present invention, it is possible to reduce the reversing Cp variation because the reversing Cp less diminishes or does not diminish when the temperature becomes closer to the glass transition temperature.

The time of the heat treatment at a temperature of the glass transition temperature ±10° C. is at least 15 minutes, preferably 30 minutes or more, more preferably 1 hour or more.

Next, the pellets are heat-treated at a temperature ranging from the glass transition temperature of polylactic acid +10° C. to the melting temperature of polylactic acid to be dried and crystallized, and thus, a polylactic acid-based resin composition having a degree of crystallinity of 30% or more is manufactured. Specifically, the pellets are kept at a temperature equal to or lower than the melting temperature of polylactic acid (80 to 180 ° C., preferably 100 to 160° C.) for 10 minutes to 50 hours, preferably for 30 minutes to 2 hours by using a jacket and/or an heated inert gas and kept in a flowing condition by using mechanical means or an inert gas.

As a device for such heat treatment, existing conical dryers and so on can be used. When a continuous operation is employed, for example, Torusdisc manufactured by Hosokawa Micron Corporation, OTWK or OTWG manufactured by Buehler can be used. In addition, in order to keep pellets in a flowing condition and inhibit a crack or a flake resulting from touching of the pellets, it is also preferable to use a rotary type or an oscillating type device. Examples of such device include a rotary kiln dryer and an oscillating dryer.

Take, for an example, a heat treatment on pellets composed of 100% polylactic acid. The pellets are preferred to be heat-treated at 60° C., which is a temperature around the glass transition temperature, for about 1 to 10 hours in order to inhibit the blocking phenomenon, and heated at 80° C. for about 15 minutes to 1 hour, and then, is dried and crystallized at 160° C., which is a temperature equal to or lower than the melting temperature, for about 30 minutes to 2 hours depending on the size of the device or the treated amount of the pellets.

It is noted that a low-molecular-weight substance in the crystallized pellets can be gasified and removed (removal of low-molecular-weight component) as needed. The removal is carried out so that the pellets are kept at a temperature ranging from the glass transition temperature of polylactic acid to the melting temperature of polylactic acid (for example, from 100 to 180° C., preferably from 140 to 170° C.) for 5 to 100 hours, preferably for 2 to 10 hours by using a jacket and/or a heated inert gas, air, or mixed gas thereof. Here, the time for keeping the pellets varies with the amount of the low-molecular-weight substance which is to be removed, a degree of vacuum, volume of airflow of the inert gas and the like, the temperature, or the like. As a device for the removal, the same device as that described above for performing the drying and crystallizing treatment with keeping the pellets in a flowing condition can be used, or a hollow cylindrical shape reactor or the like can be used without keeping the pellets in a flowing condition. The pellets after the removal of low-molecular-weight component tend to have a little higher melting temperature and a higher degree of crystallinity.

Next, the present invention will be described in more detail with reference to the Examples and the Comparative Examples.

### EXAMPLE 1

Lactide (manufactured by TOYOTA MOTOR CORPORATION) was mixed with tin octylate and dodecyl alcohol, and polymerized at an arbitrary temperature ranging from 140° C. to 190° C. for 15 to 30 hours, and then, melted and degasified by using a biaxial extrusion machine to be formed into chips. The chip was a cylindrical shape pellet having a diameter of 2 mm and a length of 3 mm.

The polylactic acid obtained by the above procedure had an MFR (melt flow rate; under the measurement conditions of 190° C. and 2.16 kg load) of 20 g/10 minutes and a weight-average molecular weight (in terms of polystyrene) of 175,000. Furthermore, the DSC measurement in accordance with JIS K7121 and K7122 revealed that the obtained polylactic acid had a midpoint glass transition temperature of 60.1° C., a melting temperature of 177.2° C., a melting heat quantity of 33.8 J/g, a content of remaining lactide of 0.3% by weight, and a degree of crystallinity of 3.5%.

The obtained pellets (raw pellets) were heat-treated in a static condition at 50° C., which was a temperature of the glass transition temperature ±10° C., for 12 hours, and the state of the blocking phenomenon in the pellets after the heat treatment was evaluated. The result is shown in Table 1. The temperature-modulated differential scanning calorimetry (modulated DSC, hereinafter referred to as MDSC) was performed on the sample after the heat treatment (device: manufactured by TA instruments). In the analysis, the temperature was raised by 2° C. from 50° C. to 80° C. with performing isothermal temperature modulation of a temperature modulation amplitude of ±0.5° C. at a temperature modulation period of 60 seconds. The isothermal temperature modulation was performed for 10 minutes at each temperature, and changes in a specific heat capacity was confirmed by using a reversing Cp (J/(g·° C.)).

The pellets after the heat treatment at 50° C. were then dried and crystallized at 120° C. for 2 hours, and the state of the blocking phenomenon was evaluated. The evaluation was conducted after loosening the dried and crystallized sample roughly. The degree of crystallinity was assessed by using the DSC.

Table 2 shows the maximum value, the minimum value, and the reversing Cp variation in a temperature range of from 50° C. to 80° C. measured by temperature-modulated differential scanning calorimetry. Table 3 shows the result of the evaluation of the state of the blocking phenomenon after the drying and crystallizing treatment. Table 4 shows the measured values of the degree of crystallinity after the heat treatment and after the drying and crystallizing treatment.

### EXAMPLE 2

The raw pellets obtained in Example 1 were heat-treated at 60° C., which was a temperature of the glass transition temperature ±10° C., for 12 hours, and the state of the blocking phenomenon was evaluated. The MDSC was performed by the same process as that in Example 1. Next, the pellets after the heat treatment at 60° C. were dried and crystallized at 120° C. for 2 hours, and the state of the blocking phenomenon was evaluated. The degree of crystallinity was measured after the heat treatment and after the drying and crystallizing treatment. The results are shown in Tables 1 to 4.

### EXAMPLE 3

The raw pellets obtained in Example 1 were heat-treated at 70° C., which was a temperature of the glass transition temperature ±10° C., for 12 hours, and the state of the blocking phenomenon was evaluated. The MDSC was performed by the same process as that in Example 1. Next, the pellets after the heat treatment at 70° C. were dried and crystallized at 120° C. for 2 hours, and the state of the blocking phenomenon was evaluated. The degree of crystallinity was measured after the heat treatment and after the drying and crystallizing treatment. The results are shown in Tables 1 to 4.

### EXAMPLE 4

In order to manufacture a masterbatch, the raw pellets obtained in Example 1 were mixed with 10% by weight of CARBODILITE LA-1 (manufactured by Nisshin Spinning Co., Ltd.) which was a hydrolysis inhibitor and then compounded. The obtained pellets were heat-treated at 60° C., which was a temperature of the glass transition temperature ±10° C., for 12 hours, and the state of the blocking phenomenon was evaluated. The MDSC was performed by the same process as that in Example 1. Next, the pellets after the heat treatment at 60° C. were dried and crystallized at 120° C. for 2 hours, and the state of the blocking phenomenon was evaluated. The degree of crystallinity was measured after the heat treatment and after the drying and crystallizing treatment. The results are shown in Tables 1 to 4.

### EXAMPLE 5

Polylactic acid having a different molecular weight was manufactured by the same process as that in Example 1 except that the added amount of dodecyl alcohol which was a molecular weight modifier was changed, and the evaluation was conducted.

The obtained polylactic acid had an MFR (melt flow rate; under the measurement conditions of 190° C. and 2.16 kg load) of 4 g/10 minutes and a weight-average molecular weight (in terms of polystyrene) of 258,000. In addition, the DSC measurement in accordance with JIS K7121 and K7122 revealed that the obtained polylactic acid had a midpoint glass transition temperature of 60.5° C., a melting temperature of 177.5° C., a melting heat quantity of 35.9 J/g, a content of remaining lactide of 0.3% by weight, and a degree of crystallinity of 2.9%.

The obtained pellets were heat-treated in a static condition at 50° C., which was a temperature of the glass transition temperature ±10° C., for 12 hours, and the state of the blocking phenomenon in the pellets after the heat treatment was evaluated. The MDSC was performed on the sample after the heat treatment by the same process as that in Example 1. Next, the pellets were dried and crystallized at 120° C. for 2 hours, and the state of the blocking phenomenon was evaluated. The degree of crystallinity was assessed by using the DSC. The results are shown in Tables 1 to 4.

### EXAMPLE 6

The raw pellets obtained in Example 5 were heat-treated at 60° C., which was a temperature of the glass transition temperature ±10° C., for 12 hours, and the state of the blocking phenomenon was evaluated. The MDSC was performed by the same process as that in Example 1. Next, the pellets after the heat treatment at 60° C. were dried and crystallized at 120° C. for 2 hours, and the state of the blocking phenomenon was evaluated. The degree of crystallinity was measured after the heat treatment and after the drying and crystallizing treatment. The results are shown in Tables 1 to 4.

### EXAMPLE 7

The raw pellets obtained in Example 5 were heat-treated at 70° C., which was a temperature of the glass transition temperature ±10° C., for 12 hours, and the state of the blocking phenomenon was evaluated. The MDSC was performed by the same process as that in Example 1. Next, the pellets after the heat treatment at 70° C. were dried and crystallized at 120° C. for 2 hours, and the state of the blocking phenomenon was evaluated. The degree of crystallinity was measured after the heat treatment and after the drying and crystallizing treatment. The results are shown in Tables 1 to 4.

### COMPARATIVE EXAMPLE 1

The MDSC was performed on the raw pellets obtained in Example 1 without performing the heat treatment by the same process as that in Example 1. Next, the pellets without the heat treatment were dried and crystallized at 120° C. for 2 hours, and the state of the blocking phenomenon was evaluated. The degree of crystallinity was measured after the drying and crystallizing treatment. The results are shown in Tables 1 to 4.

### COMPARATIVE EXAMPLE 2

The raw pellets obtained in Example 1 were heat-treated at 40° C., which was a temperature about 20° C. lower than the glass transition temperature, for 12 hours, and the state of the blocking phenomenon was evaluated. The MDSC was performed by the same process as that in Example 1. Next, the pellets after the heat treatment at 40° C. were dried and crystallized at 120° C. for 2 hours, and the state of the blocking phenomenon was evaluated. The degree of crystallinity was measured after the heat treatment and after the drying and crystallizing treatment. The results are shown in Tables 1 to 4.

### COMPARATIVE EXAMPLE 3

The raw pellets obtained in Example 1 were heat-treated at 80° C., which was a temperature about 20° C. higher than the glass transition temperature, for 12 hours, and the blocking phenomenon occurred at this point. The MDSC was performed on the pellets after the heat treatment by the same process as that in Example 1. Next, the pellets were dried and crystallized at 120° C. for 2 hours, which revealed that the blocking phenomenon occurred more prominently. The degree of crystallinity was measured after the heat treatment and after the drying and crystallizing treatment. The results are shown in Tables 1 to 4.

### COMPARATIVE EXAMPLE 4

In order to manufacture a masterbatch, the raw pellets obtained in Example 1 were mixed with 10% by weight of CARBODILITE LA-1 (manufactured by Nisshin Spinning Co., Ltd.) which was a hydrolysis inhibitor and then compounded. The MDSC was performed on the obtained pellets without performing the heat treatment by the same process as that in Example 1. Next, the pellets were dried and crystallized at 120° C. for 2 hours, and the state of the blocking phenomenon was evaluated. The degree of crystallinity was measured after the drying and crystallizing treatment. The results are shown in Tables 1 to 4.

### COMPARATIVE EXAMPLE 5

The MDSC was performed on the raw pellets obtained in Example 5 without performing the heat treatment by the same process as that in Example 1. The pellets without the heat treatment were dried and crystallized at 120° C. for 2 hours, and the state of the blocking phenomenon was evaluated. The degree of crystallinity was measured after the drying and crystallizing treatment. The results are shown in Tables 1 to 4.

### COMPARATIVE EXAMPLE 6

The raw pellets obtained in Example 5 were heat-treated at 40° C., which was a temperature about 20° C. lower than the glass transition temperature, for 12 hours, and the state of the blocking phenomenon was evaluated. The MDSC was performed by the same process as that in Example 1. Next, the pellets after the heat treatment at 40° C. were dried and crystallized at 120° C. for 2 hours, and the state of the blocking phenomenon was evaluated. The degree of crystallinity was measured after the heat treatment and after the drying and crystallizing treatment. The results are shown in Table 1.

### COMPARATIVE EXAMPLE 7

The raw pellets obtained in Example 5 were heat-treated at 80° C., which was a temperature about 20° C. higher than the glass transition temperature, for 12 hours, and the blocking phenomenon occurred at this point. The MDSC was performed on the pellets after the heat treatment by the same process as that in Example 1. Next, the pellets were dried and crystallized at 120° C. for 2 hours, which revealed that the blocking phenomenon occurred more prominently. The degree of crystallinity was measured after the heat treatment and after the drying and crystallizing treatment. The results are shown in Tables 1 to 4.

The analysis conditions in the Examples and the Comparative Examples are as follows.

<Measurement of MFR> It was measured in accordance with JIS K7210.
<Measurement of weight-average molecular weight; GPC measurement> detector manufactured by SHIMADZU CORPORATION; RID-6A, pump; LC-9A, column oven; CTO-6A, column; Shim-pack GPC-801C, -804C, -806C, -8025C were arranged in series, solvent; chloroform, flow rate; 1 ml/minute, amount of sample; 200 μl (0.5 w/w % of a sample was dissolved in chloroform), temperature of column oven; 40° C.
<Measurement of remaining lactide> A sample was immersed into acetonitrile all night and all day, and the obtained extract was analyzed by using a high-performance liquid chromatograph (HPLC) under the following conditions and calculation was carried out by using the absolute calibration method. Detector manufactured by SHIMADZU CORPORATION; SPD-6AV (UV 210 nm), pump; LC-9A, column oven; CTO-6A, column; Asahipac GF-7MHQ (7.6 mmID, 300 MML), solvent; acetonitrile, flow rate; 0.6 ml/minute, amount of sample; 10 μl
<Measurement of glass transition temperature> A midpoint glass transition temperature was measured in accordance with JIS K7121.

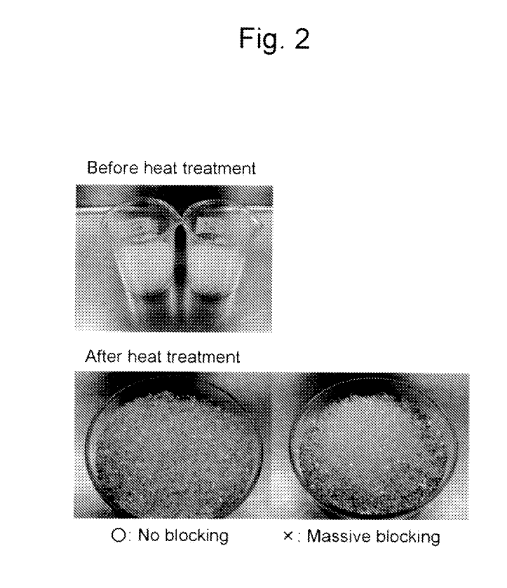

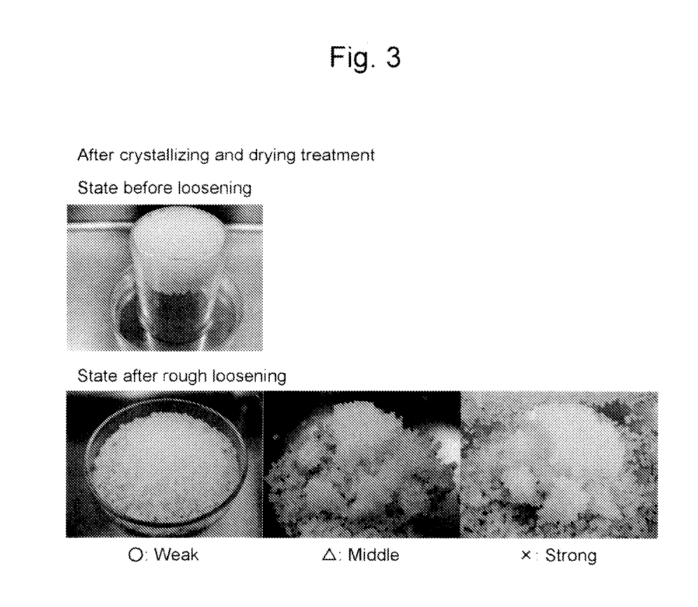

In addition, FIG. 2 represents an experiment sample before the heat treatment and an experiment sample after the heat treatment when the blocking phenomenon is evaluated. Furthermore, FIG. 3 represents an experiment sample after the drying and crystallizing treatment when the blocking phenomenon is evaluated.

TABLE 1

| | | Heat treatment | |
|---|---|---|---|
| | MFR | Temperature | State of blocking |
| | g/10 minutes | ° C. | phenomenon |
| Example 1 | 20 | 50 | ∘ |
| Example 2 | 20 | 60 | ∘ |
| Example 3 | 20 | 70 | ∘ |
| Example 4 | 20 | 60 | ∘ |
| Example 5 | 4 | 50 | ∘ |
| Example 6 | 4 | 60 | ∘ |
| Example 7 | 4 | 70 | ∘ |
| Comparative Example 1 | 20 | None | ∘ |
| Comparative Example 2 | 20 | 40 | ∘ |
| Comparative Example 3 | 20 | 80 | x |
| Comparative Example 4 | 20 | None | ∘ |
| Comparative Example 5 | 4 | None | ∘ |
| Comparative Example 6 | 4 | 40 | ∘ |
| Comparative Example 7 | 4 | 80 | x |

∘: blocking phenomenon is hardly observed
Δ: blocking phenomenon of about 5 to 10 pellets is partially observed
x: massive blocking phenomenon is observed

TABLE 2

| | Temperature-modulated differential scanning calorimetry | | |
|---|---|---|---|
| | Measured value of reversing Cp | | |
| | Maximum value | Minimum value | Range |
| | J/(g · ° C.) | J/(g · ° C.) | J/(g · ° C.) |
| Example 1 | 1.05 | 0.85 | 0.20 |
| Example 2 | 1.10 | 0.95 | 0.15 |
| Example 3 | 1.10 | 0.90 | 0.20 |
| Example 4 | 1.35 | 1.25 | 0.10 |
| Example 5 | 0.90 | 0.70 | 0.20 |
| Example 6 | 0.95 | 0.70 | 0.25 |
| Example 7 | 1.00 | 0.90 | 0.10 |
| Comparative | 1.20 | 0.70 | 0.50 |
| Example 1 | | | |
| Comparative | 1.25 | 0.75 | 0.50 |
| Example 2 | | | |
| Comparative | 1.05 | 0.95 | 0.10 |
| Example 3 | | | |
| Comparative | 1.45 | 1.00 | 0.45 |
| Example 4 | | | |
| Comparative | 1.40 | 0.90 | 0.50 |
| Example 5 | | | |
| Comparative | 1.20 | 0.75 | 0.45 |
| Example 6 | | | |
| Comparative | 1.20 | 1.05 | 0.15 |
| Example 7 | | | |

TABLE 3

| | Drying and crystallizing treatment | |
|---|---|---|
| | Temperature | State of blocking |
| | ° C. | phenomenon |
| Example 1 | 120 | ∘ |
| Example 2 | | ∘ |
| Example 3 | | ∘ |
| Example 4 | | ∘ |
| Example 5 | | ∘ |
| Example 6 | | ∘ |
| Example 7 | | ∘ |
| Comparative Example 1 | | x |
| Comparative Example 2 | | x |
| Comparative Example 3 | | x |
| Comparative Example 4 | | Δ |
| Comparative Example 5 | | x |
| Comparative Example 6 | | x |
| Comparative Example 7 | | x |

(Strength of blocking phenomenon)
∘: weak (blocking phenomenon is completely disappeared after loosening pellets roughly)
Δ: middle (blocking phenomenon is partially disappeared after loosening pellets roughly)
x: strong (blocking phenomenon cannot be loosened)
* In the experiment, a test under severe conditions that pellets are not kept in a flowing condition and are dried in a static condition under load is employed

TABLE 4

| | | | Drying and | |
|---|---|---|---|---|
| | | | crystallizing treatment | |
| | Heat treatment | | | Degree of |
| | State of | Degree of | State of | crystallinity |
| | Crystal | crystallinity | Crystal | % |
| Example 1 | Noncrystalline | 5.6 | Crystalline | 43.1 |
| Example 2 | Noncrystalline | 6.0 | Crystalline | 41.8 |
| Example 3 | Noncrystalline | 20.8 | Crystalline | 43.8 |
| Example 4 | Noncrystalline | 8.9 | Crystalline | 44.0 |
| Example 5 | Noncrystalline | 7.1 | Crystalline | 42.8 |
| Example 6 | Noncrystalline | 8.0 | Crystalline | 44.5 |
| Example 7 | Noncrystalline | 23.2 | Crystalline | 45.1 |
| Comparative | Noncrystalline | 3.5 | Crystalline | 40.9 |
| Example 1 | | | | |
| Comparative | Noncrystalline | 4.3 | Crystalline | 41.2 |
| Example 2 | | | | |
| Comparative | Crystalline | 35.7 | Crystalline | 43.2 |
| Example 3 | | | | |
| Comparative | Noncrystalline | 9.2 | Crystalline | 46.1 |
| Example 4 | | | | |
| Comparative | Noncrystalline | 3.5 | Crystalline | 42.6 |
| Example 5 | | | | |
| Comparative | Noncrystalline | 7.2 | Crystalline | 42.1 |
| Example 6 | | | | |
| Comparative | Crystalline | 32.9 | Crystalline | 47.1 |
| Example 7 | | | | |

When the pellets in the blocking state after the heat treatment were loosened one by one, the blocking phenomenon did not occur easily in the loosened pellets even if the temperature was raised again and the pellets were dried and crystallized at 120° C. This is supported by the fact that, in Comparative Example 3, the reversing Cp variation of the pellets measured by temperature-modulated differential scanning calorimetry was 0.10 J/(g·° C.), though the heat treatment at 80° C., which was a temperature outside the glass transition temperature ±10° C., caused the crystallization and the blocking phenomenon occurred.

### (Effect of Heat Treatment Time on the State of the Blocking Phenomenon)

The raw pellets obtained in Example 1 were heat-treated in a static condition at 60° C., which was a temperature of the glass transition temperature ±10° C., and then, dried and crystallized at 120° C. for 2 hours. The state of the blocking phenomenon was evaluated at different heat treatment times. The degree of crystallinity was measured by using the DSC. The results are shown in Table 5. Table 5 indicates that the heat treatment time is preferably 15 minutes or more. However, there is a possibility that the blocking phenomenon can be inhibited by performing the heat treatment, for example, in a flowing condition not in the static condition even if the heat treatment time is 5 minutes.

TABLE 5

| | | State of blocking |
|---|---|---|
| Treatment time | Degree of | phenomenon after drying |
| (minute) | crystallinity (%) | and crystallizing treatment |
| 5 | 3.0 | x |
| 15 | 5.1 | ∘ |
| 30 | 4.8 | ∘ |

### INDUSTRIAL APPLICABILITY

By using the method of the present invention, it is possible to manufacture an amorphous polylactic acid-based resin composition which can resist a blocking phenomenon. Therefore, the polylactic acid-based resin composition treated by using the method of the present invention has excellent formability in forming films, textiles, injection molded products, and the like.

All cited publications, patents, and patent applications in the above description are incorporated herein by reference as they are.

1-5. (canceled)

6. A polylactic acid-based resin composition having a degree of crystallinity of 30% or less, comprising polylactic acid and having a specific heat capacity variation of 0.4 J/(g·° C.) or less in a temperature range of from 50° C. to 80° C., the specific heat capacity variation being measured by temperature-modulated differential scanning calorimetry in which a temperature is raised from 50° C. to 80° C. by multi-stages with temperature modulation for 10 minutes at each temperature from 50° C. to 80° C. under the conditions of a temperature modulation amplitude of ±0.5° C. and a temperature modulation period of 60 seconds.

7. A method for manufacturing a polylactic acid-based resin composition having a degree of crystallinity of 30% or less according to claim 6, wherein a resin composition comprising polylactic acid or a blend of polylactic acid and another resin obtained by manufacturing the polylactic acid by polymerization or blending the polylactic acid and the another resin after manufacturing the polylactic acid is subjected to a heat treatment at a temperature of the glass transition temperature of the polylactic acid ±10° C.

8. The method for manufacturing a polylactic acid-based resin composition having a degree of crystallinity of 30% or less according to claim 7, wherein the heat treatment is performed for 15 minutes or more.

9. A method for manufacturing a polylactic acid-based resin composition having a degree of crystallinity of 30% or more, wherein a resin composition comprising polylactic acid or a blend of polylactic acid and another resin obtained by manufacturing the polylactic acid by polymerization or blending the polylactic acid and the another resin after manufacturing the polylactic acid is subjected to a heat treatment at a temperature of the glass transition temperature of polylactic acid ±10° C. to manufacture a polylactic acid-based resin composition having a degree of crystallinity of 30% or less according to claim 6, and after that, a drying and crystallizing treatment is further performed at a temperature ranging from the glass transition temperature of polylactic acid +10° C. to the melting temperature of polylactic acid.

10. The method for manufacturing a polylactic acid-based resin composition having a degree of crystallinity of 30% or less according to claim 7, wherein the heat treatment is performed at a temperature ranging from the glass transition temperature of polylactic acid −5° C. to the glass transition temperature.
